(19) United States
(12) Patent Application Publication
(10) Pub. No.: US 2024/0223828 A1
(43) Pub. Date: Jul. 4, 2024

(54) METHOD FOR PROCESSING DATA, ELECTRONIC DEVICE AND STORAGE MEDIUM

(71) Applicant: BEIJING DAJIA INTERNET INFORMATION TECHNOLOGY CO., LTD., Beijing (CN)

(72) Inventors: Yuzhang YUAN, Beijing (CN); Xinyu ZHANG, Beijing (CN)

(21) Appl. No.: 18/241,404

(22) Filed: Sep. 1, 2023

(30) Foreign Application Priority Data
Jan. 3, 2023 (CN) 202310004387.7

(51) Int. Cl. H04N 21/239; H04N 21/2187

(52) U.S. Cl. CPC H04N 21/2393; H04N 21/2187

(57) ABSTRACT

In a method for processing data, an electronic device obtains respective current interaction data of each interactive party within a target virtual interaction space in a competition state. The current interaction data includes a current number of times that the specified interactive action has been performed. The electronic device further obtains interaction quota data, a specified competition time length, and a current competition length of the target virtual interaction space. The interaction quota data includes a target number of times of performing the specified interactive action. The electronic device also sends competition end message to each interactive party in response to the current competition time length not reaching the specified competition time length and the current interaction data of an interactive party within the target virtual interaction space satisfies the interaction quota data.

### CROSS REFERENCE TO RELATED APPLICATIONS

This application is based on and claims priority to Chinese Patent Application No. 202310004387.7, filed on Jan. 3, 2013, in the China National Intellectual Property Administration, the disclosure of which is herein incorporated by reference in its entirety.

### TECHNICAL FIELD

The disclosure relates to a field of Internet technologies, in particular to a method for processing data, an electronic device and a storage medium.

### BACKGROUND

With the development of Internet live streaming (also referred as to live broadcasting) technology, there are more and more ways of live streaming. However, under a current multiplayer connection scenario, a server can only realize a single form of interaction, and thus how can the server enrich the interaction form of the current live broadcasting is an important issue for Internet live streaming platforms.

### SUMMARY

According to a first aspect of embodiments of the disclosure, a method for processing data is provided. The method includes:
obtaining respective current interaction data of each interactive party within a target virtual interaction space in a competition state, the current interaction data including a current number of times that a specified interactive action has been performed:
obtaining interaction quota data, a specified competition time length, and a current competition time length of the target virtual interaction space, the interaction quota data including a target number of times of performing the specified interactive action; and
sending competition end information to each interactive party, based on the current competition time length not reaching the specified competition time length and the current interaction data of one of interactive parties within the target virtual interaction space satisfies the interaction quota data.

According to a second aspect of embodiments of the disclosure, an electronic device is provided. The electronic device includes:
a processor: and
a memory for storing instructions executable by the processor: in which
the processor is configured to execute the instructions to perform the method for processing data according to the first aspect of the embodiments of the disclosure.

According to a third aspect of embodiments of the disclosure, a non-transitory computer-readable storage medium, having instructions stored thereon, is provided. When the instructions are executed by a processor of an electronic device, the electronic device is caused to perform the method for processing data according to the first aspect of the embodiments of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure and do not constitute an undue limitation of the disclosure.

FIG. 1 is a schematic diagram illustrating an application environment according to an embodiment.

FIG. 2 is a flowchart illustrating a method for processing data according to an embodiment.

FIG. 3 is a schematic diagram illustrating a server according to an embodiment.

FIG. 4 is a flowchart illustrating a method for processing data according to an embodiment.

FIG. 5 is a schematic diagram illustrating a server according to an embodiment.

FIG. 6 is a flowchart illustrating a process of determining a recommended interaction resource identifier and recommended quota data according to an embodiment.

FIG. 7 is a schematic diagram illustrating data interaction according to an embodiment.

FIG. 8 is a flowchart illustrating a process of determining respective current interaction data of each interactive party according to an embodiment.

FIG. 9 is a schematic diagram illustrating data interaction according to an embodiment.

FIG. 10 is a flowchart illustrating a method for processing data according to an embodiment.

FIG. 11 is a flowchart illustrating a method for processing data according to an embodiment.

FIG. 12 is a block diagram illustrating an apparatus for processing data according to an embodiment.

FIG. 13 is a block diagram illustrating an electronic device for processing data according to an embodiment.

### DETAILED DESCRIPTION

In order to enable those skilled in the art to better understand the technical solutions of the disclosure, the technical solutions in the embodiments of the disclosure will be clearly and completely described below in combination with the accompanying drawings.

It is noteworthy that the terms “first”, “second”, etc. in the specification and claims of the disclosure and the accompanying drawings are used to distinguish similar objects and do not indicate a particular order or sequence. It is understandable that the terms can be interchanged in appropriate cases, so that the embodiments of the disclosure can be practiced in an order other than those illustrated or described herein. The embodiments described in the following embodiments do not represent all embodiments consistent with the disclosure. Instead, they are only examples of devices and methods consistent with some aspects of the disclosure as described in detail in the appended claims.

It is noteworthy that user information (including, but is not limited to, user device information, user personal information, etc.) covered by this disclosure is authorized by the user or fully authorized by involved parties.

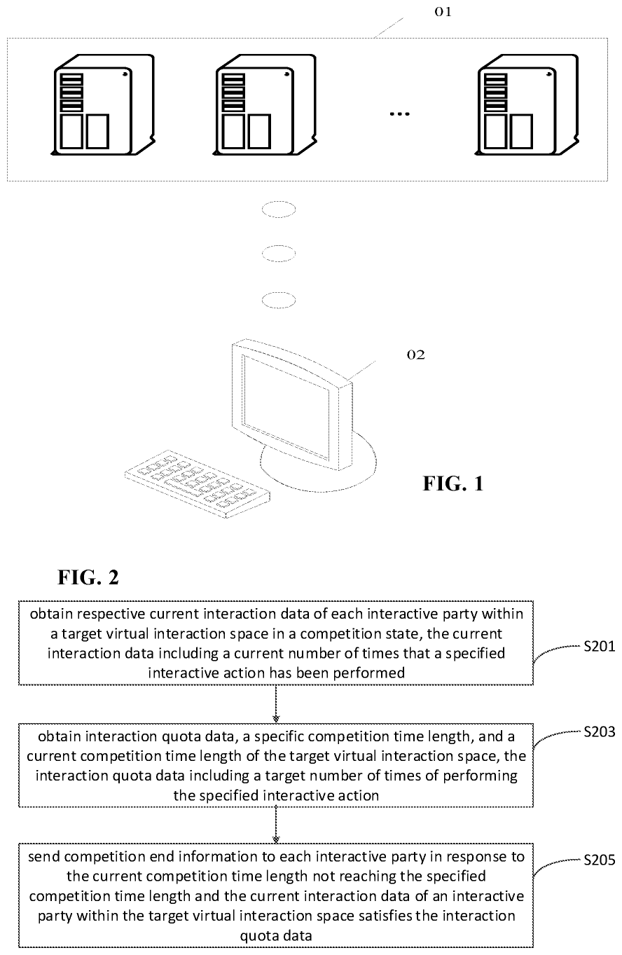

FIG. 1 is a schematic diagram illustrating an application environment of a method for processing data according to an embodiment. As illustrated in FIG. 1, the application environment may include a server 01 and at least one client 02. The server 01 may be connected to each client 02 via a wired network or a wireless network.

All clients 02 are within the same target virtual interaction space and can interact with each other. For example, in a live streaming scenario, each client 02 can be a live-streamer client, and any one of the live-streamer clients can actively initiate an interaction that is in any form. The server 01 provides an interaction data processing service for each client 02.

In detail, when the form of interaction between clients 02 is a competition form, the server 01 changes the state of the target virtual interaction space to a competition state correspondingly, and during the competition, the server 01 periodically performs the following at a certain time interval: obtaining respective current interaction data of each interactive party (i.e., each client 02), as well as interaction quota data, a specified competition time length and a current competition time length of the target virtual interaction space: determining whether the current competition time length reaches the specified competition time length: and sending competition end information to each interactive party based on the current competition time length not reaching the specified competition time length and the current interaction data of an interactive party within the target virtual interaction space satisfying the interaction quota data.

In some possible embodiments, the server 01 may be a server that provides a backend service to each client 02. In detail, the backend service provided by the server 01 may be an interaction data processing service. The service 01 may be an independent physical server, a cluster of servers or a distributed system formed by a plurality of physical servers, or a cloud server that provides basic cloud computing services such as cloud service, cloud database, cloud computing, cloud function, cloud storage, network service, cloud communication, middleware service, domain name service, security service, content delivery network (CDN), big data and artificial intelligence platform.

In some possible embodiments, the client 02 may be a smartphone, a tablet computer, a laptop, a desktop computer, etc., but is not limited thereto. The client 02 may be installed with client software for providing a human-computer interaction function, such as an application (App). The App may be a stand-alone App or subprograms in the App. For example, the App may be a news App, a live streaming App or a video App, etc.

It is understandable that the application environment illustrated in FIG. 1 is only an example, and in practical application, the method for processing data according to embodiments of the disclosure may be executed independently by the client or the server, or the method for processing data according to embodiments of the disclosure may be executed by the client in cooperation with the server, and the specific application environment is not limited in the embodiments of the disclosure.

FIG. 2 is a flowchart illustrating a method for processing data according to an embodiment.

As illustrated in FIG. 2, the method can be performed by a server. The method includes the following.

At block S201, respective current interaction data of each interactive party within a target virtual interaction space in a competition state is obtained. The current interaction data includes a current number of time that a specified interactive action has been performed.

In embodiments of the disclosure, the virtual interaction space refers to a network space supporting the viewing and the interaction of the live streaming, such as a live streaming room. The interactive parties within the same virtual interaction space may interact with each other. Taking the virtual interaction space being a live streaming room as an example, the interactive parties may be liver-streamer clients. That is, multiple liver-streamers are contained in the same live streaming room, which is known as a multi-live-streamer interaction scenario. In the multi-live-streamer interaction scenario, the live-streamer clients can connect to each other and speak to each other. In order to increase the fun of the interaction, an interactive action can be specified and each live-streamer client can do the competition regarding the specified interactive action until a winner is decided.

In embodiments of the disclosure, any interactive party in the virtual interaction space can initiate the competition, and the server decides the winner of the competition (also called winner interactive party). The server identifies the virtual interaction space in the competition state and changes the state of the virtual interaction space into the competition state, so as to differentiate it from a virtual interaction space in a normal “voice chat” state.

Due to the popularity of live streaming Apps, at any moment, there may be a large number of virtual interaction spaces that are currently in the competition state. As illustrated in FIG. 3, at the current moment, there are N virtual interaction spaces in the competition state stored in the server, i.e., virtual interaction space 1, . . . , virtual interaction space N. Each virtual interaction space contains a certain number of interactive parties. For example, the virtual interaction space contains interactive party 1, . . . , interactive party m, where 1, . . . , N and 1, . . . , m are all natural numbers, and these numbers are used to indicate the identifiers of the virtual interaction spaces and the identifiers of the interactive parties respectively. It is understandable that using these numbers to represent the identifiers is only an example, which are not intended for limiting the disclosure. For each virtual interaction space in the competition state, the server may determine the respective winner interactive party for each virtual interaction space through the same processing method, and the form of the competition of each virtual interaction space is not limited. Therefore, at blocks S201 to S203 of the embodiments of the disclosure, the target virtual interaction space refers to any one of the large number of virtual interaction spaces in the competition state existing at the current moment. The disclosure is described by using the target virtual interaction space as an example, to illustrate the data processing process of the server in making the decision.

In embodiments of the disclosure, multiple pieces of interaction data will be used by the server to make the decision in performing the blocks S201 to S203, including the respective current interaction data of each interactive party, the interaction quota data, the specified competition time length, and the current competition time length. The interaction quota data and the specified competition time length are obtained by the server from a certain interaction party. e.g., from the target interactive party which will be described below, when the space enters the competition state. Therefore, before introducing the blocks S201 to S203 in detail, the data processing process of the server when the space enters the competition state at the beginning will be introduced by taking the target virtual interaction space as an example.

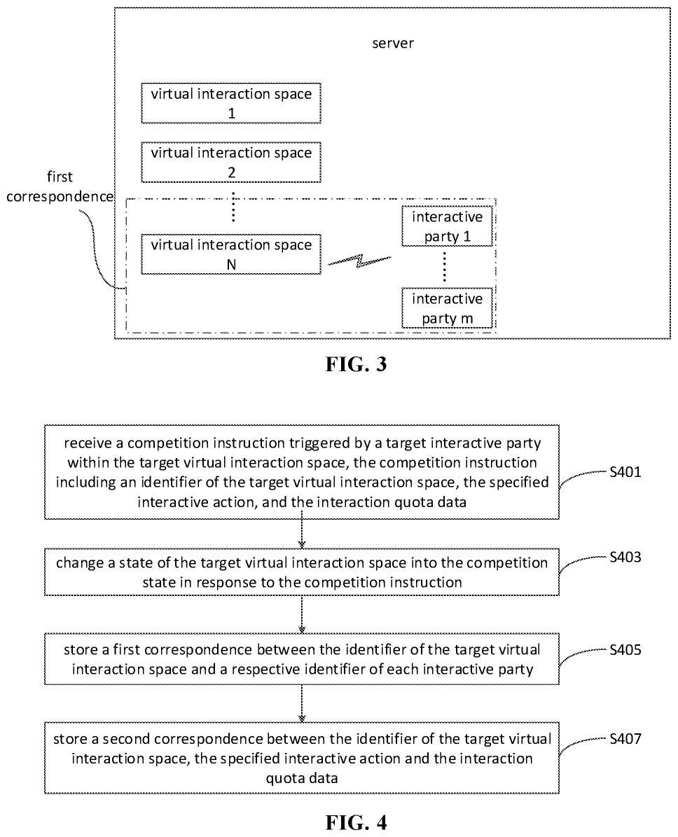

Correspondingly, in some possible embodiments, before the block S201, the method for processing data according to embodiments of the disclosure further includes the following as illustrated in FIG. 4.

At block S401, a competition instruction triggered by a target interactive party within the target virtual interaction space is received. The competition instruction includes an identifier of the target virtual interaction space, the specified interactive action, and the interaction quota data.

The target interactive party is a party initiating the competition (also called initiating party), which can be any one of the multiple interactive parties within the target virtual interaction space. The target interactive party, as the party initiating the competition, can determine the specified interactive action and the interaction quota data on its client interface when initiating the competition interaction, and then trigger the generation of the competition instruction. The competition instruction carries the identifier of the target virtual interaction space corresponding to the target interactive party, as well as the specified interactive action and the interaction quota data determined by the target interactive party. The target interactive party sends the competition instruction to the server and requests to enter the competition state.

Correspondingly, upon receiving the competition instruction sent by the target interactive party, the server may obtain the identifier of the target virtual interaction space, the specified interactive action, and the interaction quota data from the competition instruction. The server may determine the identifier of the target interactive party that sends the competition instruction as an identifier of the party for initiating the competition.

The identifier of the target virtual interaction space may be a number as described above, or may be in other forms, such as letters, special symbols, etc., and the same with the identifier of the interactive party, which is not repeated herein.

At block S403, in response to the competition instruction, a state of the target virtual interaction space is changed into the competition state.

In detail, in response to the competition instruction, the server may perform a competition condition-based verification, change the state of the target virtual interaction space into the competition state after passing the competition condition-based verification, and send a prompt message to each interactive party within the target virtual interaction space for prompting each interactive party that the competition state is entered.

The competition condition may include, but is not limited to, whether an account attribute of a respective live-streamer account corresponding to each interactive party within the target virtual interaction space satisfies a preset attribute value, and whether a maximum number difference regarding the number of viewers among the interactive parities reaches a number difference threshold. The maximum number difference means a difference between the number of viewers for an interactive party and the interaction quota data. For example, the account attribute is “age”, and the corresponding preset attribute value is “18”. The number difference threshold can be dynamically adjusted depending on the interaction quota data. When the maximum number difference regarding the number of viewers exceeds the number difference threshold, for example, when the number of viewers in a live streaming room is one million, the number of viewers in another live streaming room is 100 thousand, and the interaction quota data is one million, such that the maximum number difference is 900 thousand, it is obvious that the interaction quota data is too high for the interactive party with fewer viewers, and thus the competition is irrational. To avoid this irrationality, the server can set the corresponding competition condition, i.e., the number difference threshold, to 600 thousand, so that the competition that does not satisfy the competition condition can be avoided through the competition condition-based verification.

At block S405, a first correspondence between the identifier of the target virtual interaction space and a respective identifier of each interactive party is stored.

In detail, after changing the state of the target virtual interaction space into the competition state, the server stores the first correspondence between the identifier of the target virtual interaction space and the respective identifier of each interactive party. For example, as illustrated in FIG. 3, after determining that the target virtual interaction space N is in the competition state, the server stores the first correspondence between the target virtual interaction space N and the interactive parties 1 to m within the target virtual interaction space. It is understandable that the server also has stored the first correspondence of the virtual interaction space 1, the first correspondence of the virtual interaction space 2, and so on previously.

At block S407, a second correspondence between the identifier of the target virtual interaction space, the specified interactive action and the interaction quota data is stored.

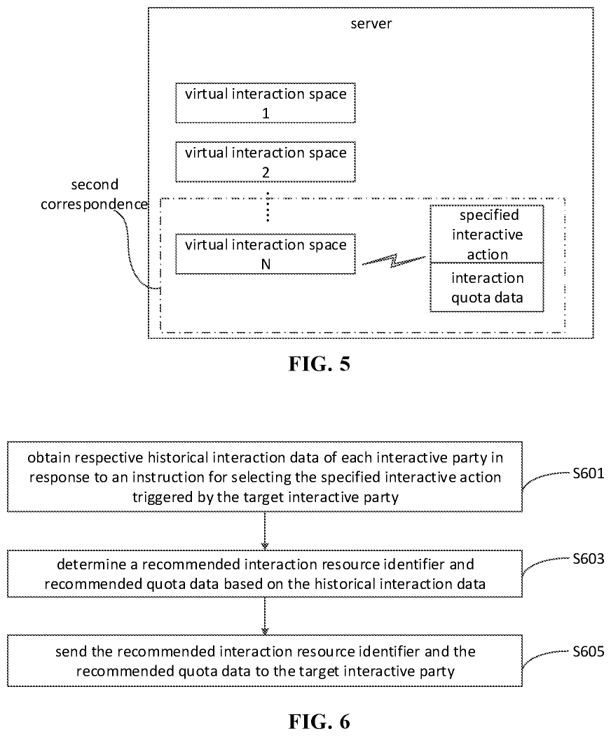

In detail, in addition to the first correspondence of the target virtual interaction space, the server also stores the second correspondence between the identifier of the target virtual interaction space, the specified interactive action and the interaction quota data. As described above, the specified interactive action and the interaction quota data are obtained from the target interactive party. As illustrated in FIG. 5, the server stores the second correspondence between the target virtual interaction space N, and the specified interactive action and the interaction quota data of the target virtual interaction space N. As an example, the specified interactive action can be “commenting”, and the corresponding interaction quota data can be that the quantity is one million, which will be introduced later and will not be repeated herein. It is understandable that the server also has stored the second correspondence of the virtual interaction space 1, the second correspondence of the virtual interaction space 2 and so on previously.

In practice, the server creates an entity “scoreLineChat” corresponding to the target virtual interaction space. The entity “scoreLineChat” contains the specified interactive action and the interaction quota data of the target virtual interaction space. Meanwhile, mappings from the identifiers of all interactive parties to an identity of the entity “scoreLineChat” (scoreLineChatId) are established and stored in a database “redis”.

With the above embodiments, the server determines whether the competition condition is satisfied in response to the competition instruction initiated by the target interactive party, so as to avoid irrational competitions and improve the interaction security of the virtual interaction space. Relevant data and correspondences of the target virtual interaction space in the competition state are stored, to improve data support for subsequent implementations of deciding the winner interactive party.

In embodiments of the disclosure, the target interactive party determines the specified interactive action and the interaction quota data, and sends the competition instruction carrying the specified interactive action and the interaction quota data to the server. The specified interactive action indicates the form of the competition initiated by the target interactive party. For example, the form of the competition includes, but is not limited to, gift competition, comment competition, likes competition, and any other operational interactive action. The interaction quota data indicates a target number of times of performing the specified interactive action. After entering the competition state, within the specified competition time length, if the number of times that an interactive party within the target virtual interaction space performs the specified interactive action reaches the target number of times, the winner can be determined in advance. The specified competition time length can be determined by the target interactive party, carried in the competition instruction and sent to the server, or the specified competition time length can also be determined directly by the server.

In some possible embodiments, before the block S401, the method according to embodiments of the disclosure may further include the following as illustrated in FIG. 6.

At block S601, respective historical interaction data of each interactive party is obtained in response to an instruction for selecting the specified interactive action triggered by the target interactive party.

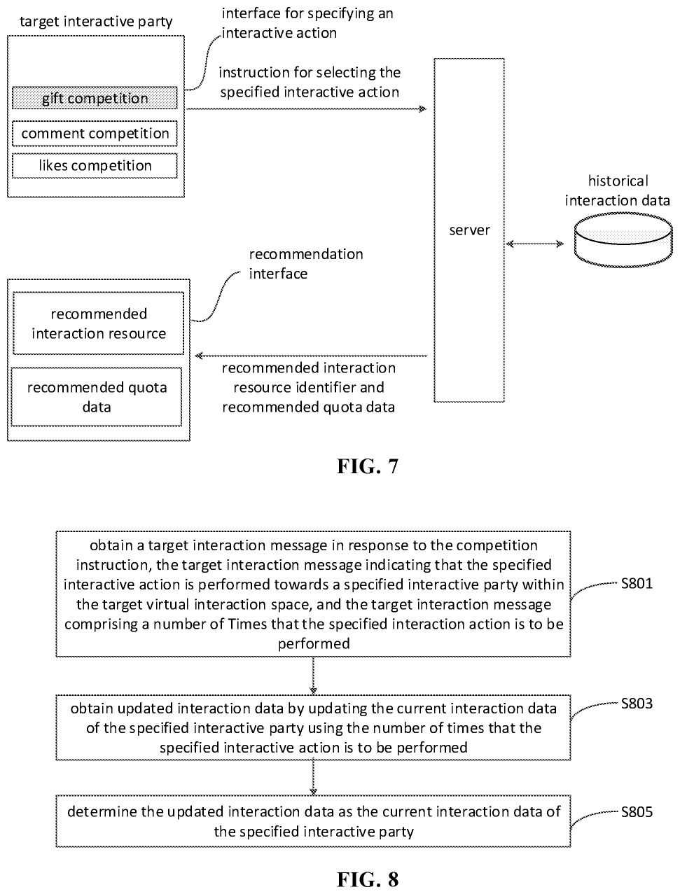

At this block, when the target interactive party initiates the competition, the form of the competition may be determined. In detail, as illustrated in FIG. 7, an interface for specifying an interactive action is displayed at the target interactive party, and the instruction for selecting the specified interactive action is generated by a trigger operation on the interface for specifying the interactive action of the target interactive party. For example, the interface for specifying the interactive action displays three forms of competition, i.e., gift competition, comment competition, and likes competition. When the user selects the gift competition, the gift competition is determined as the specified interactive action.

After determining the specified interactive action, the target interactive party can determine the specified interaction resource for the specified interactive action. For example, in a live streaming scenario, there are many types of gifts. The target interactive party can compete with other interactive parties by specifying one type of gift. In order to facilitate user selection, the server can actively specify the interaction resource for the target interactive party, for example, by specifying and recommending the gift type.

Correspondingly, the instruction for selecting the specified interactive action may carry the identifier of the target virtual interaction space. In detail, in response to the instruction for selecting the specified interactive action triggered by the target interactive party, the server determines the respective identifier of each interactive party within the target virtual interaction space based on the identifier of the target virtual interaction space carried in the instruction for selecting the specified interactive action. The server obtains the respective historical interaction data of each interactive party from the database based on the respective identifier of each interactive party. The historical interaction data of an interactive party includes the historical interaction resource identifiers and the numbers of historical interactions respectively corresponding to the historical interaction resource identifiers. Based on the respective historical interaction data of each interactive party, the server recommends the specified interaction resource and the interaction quota data to the target interactive party.

The historical interaction resource identifiers are identifiers of interaction resources received by the interactive party from its viewer clients within a historical time period. The corresponding number of historical interactions refers to the number of the corresponding interaction resources received by the corresponding interactive party within the historical time period. The historical time period may be set according to actual needs, for example, one month, two months, and so on.

For example, in a scenario where the specified interactive action is in the form of gift competition, the historical interaction resource identifiers include identifiers of the gifts received by the interactive party in the past one month. The number of historical interactions includes the number of times of receiving the gifts per gift type. For example, the historical interaction data of the target interactive party may include ten thousand “rockets” and 100 thousand “flowers” received in the past 1 month.

At block S603, a recommended interaction resource identifier and recommended quota data are determined based on the respective historical interaction data of each interactive party.

At block S605, the recommended interaction resource identifier and the recommended quota data are sent to the target interactive party.

In the above blocks, the server determines the recommended interaction resource identifier and the recommended quota data after obtaining the respective historical interaction resource identifier of each interactive party and the numbers of historical interactions corresponding to the historical interaction resource identifiers, and then sends the recommended interaction resource identifier and the recommended quota data to the target interactive party. As illustrated in FIG. 7, the target interactive party can display the recommended interaction resource identifier and the recommended quota data on a corresponding recommendation interface. There may be one or more groups of the recommended interaction resource identifier and the recommended quota data.

In a specific embodiment, the server may find out each same historical interaction resource identifier among the interactive parties, and determine the recommended interaction resource identifier and the recommended quota data based on the data found out. The server can directly use the historical interaction resource identifiers of an interactive party as the recommended interaction resource identifiers and use the numbers of historical interactions corresponding to the historical interaction resource identifiers as the recommended indicator data according to a specified algorithm, or the numbers of historical interactions corresponding to the historical interaction resource identifiers can be adjusted and the adjusted data can be used as the recommended quota data.

For example, in the scenario where the specified interactive action is in the form of gift competition, after the server finds out the respective identifier of each same gift type among the interactive parties, the historical interaction data of the interactive party 1 includes 10 thousand “rockets” and 100 thousand “flowers”, the historical interaction data of the interactive party 2 includes 20 thousand “rockets” and 150 thousand “flowers”, and the historical interaction data of the interactive party 3 includes 30 thousand “rockets” and 50 thousand “flowers”. In a specific algorithm, the server can directly determine an identifier of the gift corresponding to the largest number as the recommended interaction resource identifier based on the respective number of gifts corresponding to each gift type, and the largest number is the recommended quota data. In this case, the “flower” is taken as the recommended interaction resource, and the recommended quota data is “150 thousand”. In another specific algorithm, the server can also determine the recommended interaction resource identifier by considering a virtual value of the interaction resource. For example, the virtual value of the “rocket” is 80 and the virtual value of the “flower” is 10, and thus the server determines the recommended quota data for each gift type based on a product of the virtual value and the number of gifts. Therefore, the recommended quota data of “30 thousand rockets” is highest, and thus the “rocket” is used as the recommended interaction resource and the recommended quota data is determined as “30 thousand”. The specific algorithms described above are examples of the embodiments of the disclosure, and can be flexibly adjusted in practical application.

In the above embodiment, after the target interactive party determines the specified interactive action, the server may recommend the specified interaction resource and the interaction quota data to the target interactive party, especially in the case where the specified interactive action is in the form of gift competition, so that the process of initiating the competition by the target interactive party can be simplified, which helps to quickly enter the competition state. Moreover, the server determines the recommended interaction resource identifier and the recommended quota data based on the respective historical interaction data of each interactive party. By considering the condition of each interactive party, a competition goal can be more reasonable, which reduces the gap between different interactive parties, so as to improve the fun of interaction.

In embodiments of the disclosure, when the target virtual interaction space is in the competition state, the server needs to count the respective number of specified actions for each interactive party, to determine the respective current interaction data of each interactive party. Therefore, in some possible embodiments, the method for processing data according to embodiments of the disclosure also includes the following as illustrated in FIG. 8.

At block S801, a target interaction message is obtained in response to the competition instruction. The target interaction message indicates that the specified interactive action is performed towards a specified interactive party within the target virtual interaction space. The target interaction message includes a number of times that the specified interactive action is to be performed.

The specified interactive party can be any one of the interactive parties within the target virtual interaction space.

At this block, after the server changes the state of the target virtual interaction space into the competition state in response to the competition instruction, the server obtains the target interaction message for indicating that the specified interactive action is performed towards an interactive party within the target virtual interaction space. The target interaction message is triggered by a viewer client of the interactive party when the viewer client implements the specified interactive action towards the interactive party. The target interaction message includes a number of times that the viewer client performs the specified interactive actions towards to the specified interactive party.

At block S803, updated interaction data is obtained by updating the current interaction data of the specified interactive party using the number of times that the specified interactive action is to be performed.

At block S805, the updated interaction data is determined as the current interaction data of the specified interactive party.

The current interaction data is the current number of times that the specified interactive action has been performed. When the server updates the current interaction data of the specified interactive party for the first time, the current interaction data is 0. For subsequent update, the server obtains the current interaction data of the specified interactive party, obtains a sum of the current interaction data and the number of times that the specified interactive action is to be performed, as the updated interaction data, and determines the updated interaction data as the current interaction data of the specified interactive party.

In the above embodiment, the server obtains the target interaction messages when the target virtual interaction space is in the competition state, counts the respective number of times of performing the specified action towards each interactive party, and updates the respective current interaction data of each interactive party in a timely manner, which can ensure the accuracy when the server makes a decision about the competition.

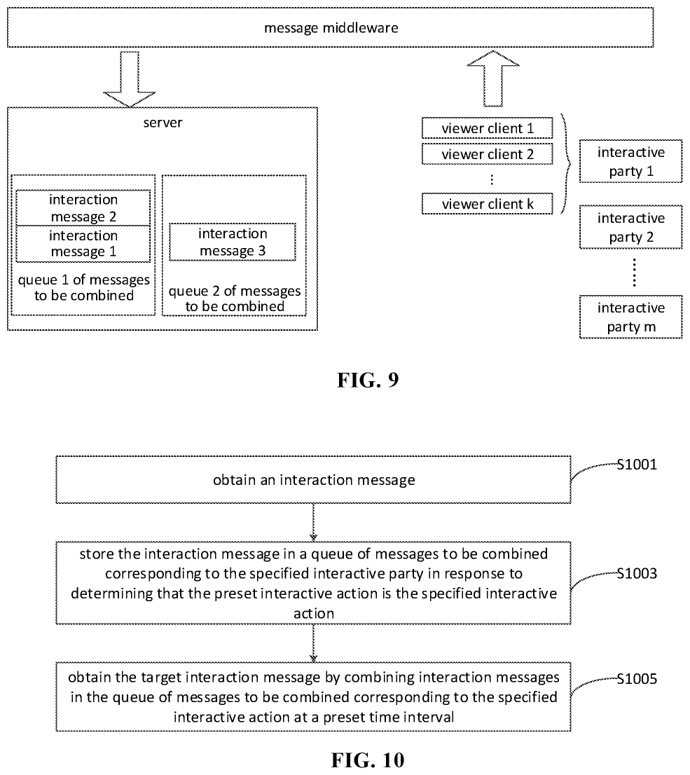

In practice, as illustrated in FIG. 9, there are a large number of viewer clients for each interactive party. The viewer clients initiate a large number of interactive actions towards the corresponding interactive party. Each interaction message triggered by an interactive action includes the identifier of the specified interactive party, and the interaction message indicates that a preset interactive action is performed towards the specified interactive party. The preset interactive action is specified by the viewer client, including commenting, giving likes, giving a gift, etc. Different interaction messages can correspond to different preset interactive actions.

In a specific embodiment, obtaining the target interaction message may include the following as illustrated in FIG. 10.

At block S1001, an interaction message is obtained.

At this block, the server can obtain the interaction message from a message middleware. A large number of different types of messages will be triggered by the viewer clients while the viewer clients is viewing the competition among the interactive parties within the target virtual interaction space, including not only the interaction messages, but also shopping messages. These different types of messages are received by the message middleware and are classified uniformly, so that the server can obtain the actually needed type of message directly from the message middleware according to the actual requirements, i.e., the interaction messages.

In detail, the server may obtain all interaction messages within the target virtual interaction space from the message middleware based on the identifier of the target virtual interaction space. Or, the server may obtain interaction messages for each interactive party from the message middleware based on the respective identifier of each interactive party.

For example, as illustrated in FIG. 9, assuming the scenario is a gift competition scenario, the server can obtain the following interaction messages by any of the above ways: interaction message 1 {sends to the interactive party 1, 1 rocket}, interaction message 2 {sends to the interactive party 1, 1 rocket}, interaction message 3 {sends to the interactive party 2, 5 rockets}, interaction message 4 {sends to the interactive party 2, 10 flowers}, and interaction message 5 {sends to the interactive party 2, 1 likes}.

At block S1003, the interaction message is stored in a queue of messages to be combined corresponding to the specified interactive party, in response to determining that the preset interactive action is the specified interactive action.

At this block, the server screens the interaction messages, and determines whether the preset interactive action in each interaction message is the specified interactive action. Before the server determines whether the preset interactive action is the specified interactive action, the server needs to know what the specified interactive action is at first. In a specific embodiment, the server firstly determines the identifier of the target virtual interaction space corresponding to the identifier of the specified interactive party according to the first correspondence stored in advance, based on the identifier of the specified interactive party in the interaction message. Secondly, the server determines the specified interactive action corresponding to the identifier of the target virtual interaction space based on the second correspondence stored in advance.

If the server determines that the preset interactive action is the specified interactive action, the server stores the interaction message in the queue of messages to be combined corresponding to the specified interactive party temporarily. For example, in the above example, since the specified interactive action is the gift competition, while the preset interactive action is giving likes which is not the specified interactive action, the server will filter out the interaction message 5.

It is noteworthy that if the specified interactive action is the gift competition, it also needs to further judge whether the interaction resource in the interaction message is the specified interaction resource. For example, in the above example, since the interaction resource is “flower”, which does not satisfy the specified interaction resource, i.e., “rocket”, the server filters out the interaction message 4. As illustrated in FIG. 9, the server finally stores the interaction message 1 and the interaction message 2 into a queue 1 of messages to be combined corresponding to the interactive party 1, and stores the interaction message 3 into a queue 2 of messages to be combined corresponding to the interactive party 2.

At block S1005, the target interaction message is obtained by combining interaction messages in the queue of messages to be combined corresponding to the specified interactive party at a preset time interval.

In detail, the server may perform the blocks S1001 to S1003 every time when an interaction message is acquired, but the server may perform the block S1005 of combining the interaction messages in the queue of messages to be combined corresponding to the specified interactive party at the preset time interval by setting up a timing task, to obtain the target interaction message. The preset time interval may be dynamically adjusted according to a frequency of obtaining the interaction messages in the actual application scenario. When the interaction messages are obtained more frequently, the preset time interval may be set smaller. For example, the preset time interval may be 1 second.

In detail, when the server combines the interaction messages in the queue of messages to be combined corresponding to the specified interactive party, the server sums up the number of times of performing the specified interactive action in each interaction message in the queue of messages to be combined corresponding to each interactive party, and generates the corresponding target interaction message based on a summation result. That is, the number of times that the specified interactive action is to be performed in the target interaction message is a sum of the numbers of times of performing the specified interactive action in all the interaction messages in the queue of messages to be combined.

In other embodiments, the server can also update the current interaction data corresponding to the specified interactive party once every time the server obtains an interaction message. In practice, the server queries the mapping in the database “redis” according to the identifier of the specified interactive party in the interaction message (storage structure: liveId->scoreLineChatId), to determine whether the specified interactive party is in the competition mode. If the specified interactive party is in the competition state, the server queries the entity “scoreLineChat” based on the scoreLineChatId, and determines whether the preset interactive action in the interaction message is the specified interactive action. If the preset interactive action is the specified interactive action, the current interaction data (storage structure: scoreLineChatId_userId: score) of the specified interactive party is updated in the database “redis”, in which “userId” represents the identifier of the account of the specified interactive party, and “score” represents the current interaction data.

In the above embodiments, after storing a batch of interaction messages in a local message queue at the preset time interval, the server updates the respective current interaction data of each interactive party at one time by combining the interaction messages. Therefore, compared to the way of updating the respective current interaction data of the each interactive party every time an interaction message is received, a hotspot problem caused by a large number of concurrent interaction messages that need to be updated for the popular interactive party can be prevented, which prevents the server from crash anomaly.

At block S203, interaction quota data, a specified competition time length, and a current competition time length of the target virtual interaction space are obtained. The interaction quota data includes a target number of times of performing the specified interactive action.

In embodiments of the disclosure, the server may set a timing task to periodically execute blocks S201 to S205. For example, the time interval may be 1 second. In this way, the timeliness of deciding the winner of the competition can be improved. When the server makes the decision, on the one hand, the server obtains the respective current interaction data of each interactive party within the target virtual interaction space, and on the other hand, the server also obtains the interaction quota data, the specified competition time length, and the current competition time length of the target virtual interaction space. The current interaction data, the interaction quota data, and the specified competition time length have been described in the above embodiments and are not repeated herein. The current competition time length may be a time interval from the moment when the server determines that the target virtual interaction space is in the competition mode to the current moment.

At block S205, competition end information is sent to each interactive party based on the current competition time duration not reaching the specified competition time length and the current interaction data of any interactive party within the target virtual interaction space satisfies the interaction quota data.

In embodiments of the disclosure, the competition end information may include an identifier of a winner (or called winner interactive party) among the interactive parties participating in the competition. When the current competition time length does not reach the specified competition time length, if the current interaction data of any interactive party within the target virtual interaction space satisfies the interaction quota data, the server can end the competition in advance, determine the interactive party whose current interaction data satisfies the interaction quota data as the winner interactive party, and send the competition end information to each interactive party.

If the current competition time length reaches the specified competition time length, the server obtains the respective current interaction data of each interactive party, determines an interactive party whose current interaction data is the largest as the winner interactive party, and sends the competition end information to each interactive party.

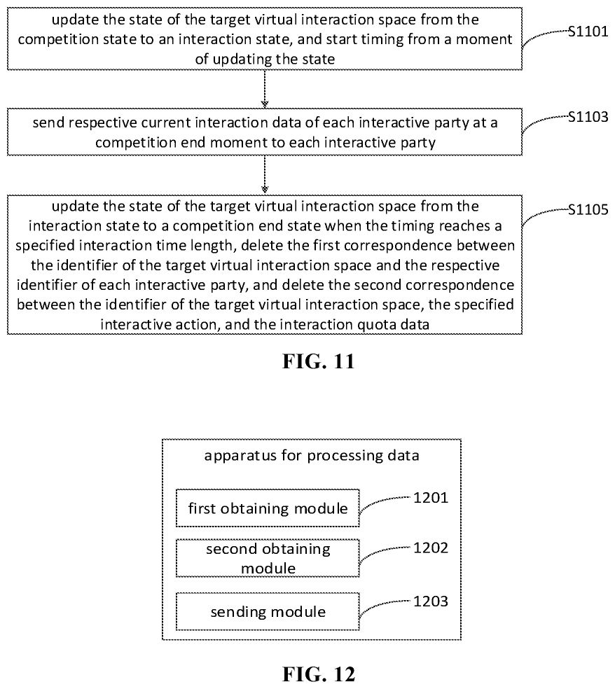

In some possible embodiments, in order to further improve the fun of competition interaction, after sending the competition end information to each interactive party, the method for processing data according to embodiments of the disclosure may also include the following as illustrated in FIG. 11.

At block S1101, the state of the target virtual interaction space is adjusted from the competition state to an interaction state, and timing is started from a moment of updating the state.

At this block, after the competition is over, the server updates the state of the target virtual interaction space from the competition state to the interaction state, and the interactive parties in the interaction state within the target virtual interaction space can interact with each other with respect to the competition result. For example, the live streamer at the winner interactive party honors a winning promise, and the live streamer at the interactive party that has lost the competition honors a losing promise. The server can place a time limit on the interaction state by starting timing at the moment of updating the interaction state.

At block S1103, respective current interaction data of each interactive party at a competition end moment is sent to each interactive party.

At this block, the server sends the respective current interaction data of each interactive party at the competition end moment to each interactive party. Certainly, the server can send the respective current interaction data of each interactive party to each interactive party in real time when the space is in the competition state, so as to facilitate each interactive party to understand the current competition progress in a timely manner, and to improve the interaction motivation of each viewer client.

At block S1105, when the timing reaches a specified interaction time duration, the first correspondence between the identifier of the target virtual interaction space and the respective identifier of each interactive party, and the second correspondence between the identifier of the target virtual interaction space, the specified interactive action, and the interaction quota data are deleted.

The specified interaction time length may be a fixed time length set by the server, for example, 30 seconds, and 1 minute.

At this block, when the timing reaches the specified interaction time length, the server changes the state of the target virtual interaction space from the interaction state to a normal “voice chat” state, deletes the first correspondence between the identifier of the target virtual interaction space and the respective identifier of each interactive party, deletes the first correspondence between the identifier of the target virtual interaction space, the specified interactive action and the interaction quota data, and releases a server storage space. Subsequently, the target virtual interaction space can re-enter into the competition state.

In the above embodiments, after the competition in the target virtual interaction space is over, the server does not directly change the state of the target virtual interaction space to the normal “voice chat” state, but to the interaction state, such that the competition result is displayed for each interactive party within the target virtual interaction space in the interaction state. From the beginning to the end of the entire interaction process of the competition, the viewer clients have a high degree of participation, the fun of interaction is high, and the user satisfaction degree can be improved.

In conclusion, with the method for processing data according to embodiments of the disclosure, the interaction quota data, the specified competition time length and the current competition time length of the target virtual interaction space in the competition state and the respective current interaction data of each interactive party are obtained periodically for judgment. In the case that the current competition time length does not reach the specified competition time length, if the current interaction data of any interactive party within the target virtual interaction space satisfies the interaction quota data, there is no need to wait for the expiration of the specified competition time length, the winner interactive party can be determined in advance, and the competition end information is sent to each interactive party. In this way, the flexibility of determining the winner interactive party can be improved. Since the competition can be ended in advance, the motivation of interaction of the viewer clients participating in the entire stage from the beginning of the competition to the end of the competition can be mobilized, which can enhance the activity of the viewer clients throughout the stage of the competition, so that the fun of interaction can be enhanced, and the user viscosity can be improved.

FIG. 12 is a block diagram illustrating an apparatus for processing data according to an embodiment. As illustrated in FIG. 12, the apparatus includes a first obtaining module 1201, a second obtaining module 1202, and a sending module 1203.

The first obtaining module 1201 is configured to obtain respective current interaction data of each interactive party within a target virtual interaction space in a competition state. The current interaction data includes a current number of times that a specified interactive action has been performed.

The second obtaining module 1202 is configured to obtain interaction quota data, a specified competition time length, and a current competition time length of the target virtual interaction space. The interaction quota data includes a target number of times of performing the specified interactive action.

The sending module 1203 is configured to send competition end information to each interactive party based on the current competition time length not reaching the specified competition time length and the current interaction data of an interactive party within the target virtual interaction space satisfies the interaction quota data.

In some possible embodiments, the apparatus further includes a receiving module.

The receiving module is configured to receive a competition instruction triggered by a target interactive party within the target virtual interaction space. The competition instruction includes an identifier of the target virtual interaction space, the specified interactive action, and the interaction quota data. The receiving module is further configured to change a state of the target virtual interaction space into the competition state in response to the competition instruction: store a first correspondence between the identifier of the target virtual interaction space and a respective identifier of each interactive party: and store a second correspondence between the identifier of the target virtual interaction space, the specified interactive action and the interaction quota data.

In some possible embodiments, the apparatus further includes an updating module.

The updating module is configured to obtain a target interaction message in response to the competition instruction. The target interaction message indicates that the specified interactive action is performed towards a specified interactive party within the target virtual interaction space, and the target interaction message includes a number of times that the specified interactive action is to be performed. The updating module is further configured to obtain updated interaction data by updating the current interaction data of the specified interactive party using the number of times that the specified interactive action is to be performed: and determine the updated interaction data as the current interaction data of the specified interactive party.

In some possible embodiments, the updating module is further configured to: obtain an interaction message. The interaction message includes an identifier of the specified interactive party, and the interaction message indicates that a preset interactive action is performed towards the specified interactive party. The updating module is further configured to store the interaction message in a queue of messages to be combined corresponding to the specified interactive party in response to determining that the preset interactive action is the specified interactive action: and obtain the target interaction message by combining interaction messages in the queue of messages to be combined corresponding to the specified interactive party at a preset time interval.

In some possible embodiments, the updating module is further configured to: determine the identifier of the target virtual interaction space corresponding to an identifier of the specified interactive action based on the first correspondence: and determine the specified interactive action corresponding to the identifier of the target virtual interaction space based on the second correspondence.

In some possible embodiments, the apparatus further includes a recommending module.

The recommending module is configured to obtain respective historical interaction data of each interactive party in response to an instruction for selecting the specified interactive action triggered by the target interactive party. The historical interaction data includes a plurality of historical interaction resource identifiers and respective numbers of historical interactions corresponding to the plurality of historical interaction resource identifiers. The recommending module is further configured to determine a recommended interaction resource identifier and recommended quota data based on the respective historical interaction data of each interactive party: and send the recommended interaction resource identifier and the recommended quota data to each interactive party.

In some possible embodiments, the apparatus further includes a timing module.

The timing module is configured to change the state of the target virtual interaction space from the competition state to an interaction state, and start timing from a moment of updating the state: send respective current interaction data of each interactive party at a competition end moment to each interactive party: change the state of the target virtual interaction space from the interaction state to a competition end state when the timing reaches a specified interaction time duration, delete the first correspondence between the identifier of the target virtual interaction space and the respective identifier of each interactive party, and delete the second correspondence between the identifier of the target virtual interaction space, the specified interactive action and the interaction quota data.

With respect to the apparatus in the above embodiments, the specified manner in which each module performs an operation has been described in detail in the method embodiments, and will not be described in detail herein.

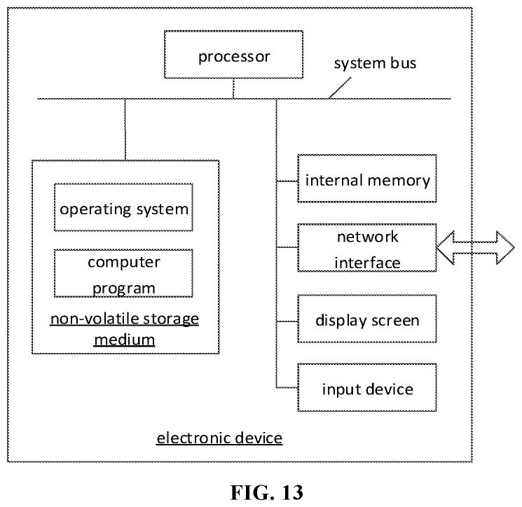

FIG. 13 is a block diagram illustrating an electronic device for data processing according to an embodiment. The electronic device may be a terminal, and the internal structure of which may be illustrated in FIG. 13. The electronic device includes a processor, a memory, a network interface, a display screen, and an input device that are connected via system buses. The processor of the electronic device is used to provide computing and control capabilities. The memory of the electronic device includes a non-volatile storage medium and an internal memory. The non-volatile storage medium stores an operating system and computer programs. The internal memory provides an environment for the operation of the operating system and the computer programs in the non-volatile storage medium. The network interface of the electronic device is used to communicate with an external terminal via a network connection. The computer programs are executed by the processor to implement the method for processing data. The display screen of the electronic device may be a liquid crystal display or an electronic ink display. The input device of the electronic device may be a touch layer covered on the display screen, or a button, a trackball or a touchpad provided on a housing of the electronic device, or an external keyboard, a touchpad or a mouse.

It is understandable by those skilled in the art that the structure illustrated in FIG. 13 is only a block diagram of a portion of the structure related to the presently disclosed embodiment, and does not constitute a limitation on the electronic device to which the presently disclosed embodiment is applied. The specific electronic device may include more or fewer components than those shown in the figures or combined components, or have different arrangements of components.

In an embodiment, an electronic device is provided. The electronic device includes: a processor and a memory for storing instructions executable by the processor. The processor is configured to execute the instructions to implement the method for processing data according to embodiments of the disclosure.

In an embodiment, a computer-readable storage medium having instructions stored thereon is provided. When the instructions are executed by the processor of the electronic device, the electronic device is caused to implement the method for processing data according to embodiments of the disclosure.

In an embodiment, a computer program product including computer programs is provided. The computer programs are stored in the readable storage medium, and at least one processor of the computer device reads and executes the computer programs from the readable storage medium, and the computer device is caused to implement the method for processing data according to embodiments of the disclosure.

It is understandable by those skilled in the art that all or part of the processes in the method embodiments described above can be implemented by instructing the associated hardware through computer programs. The computer programs may be stored in a non-volatile computer-readable storage medium. When the computer programs are executed, the process of the method embodiments described above may be implemented. Any reference to the memory, storage, database, or other mediums used in the embodiments provided in this disclosure may include non-volatile and/or volatile memories. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. By way of illustration and not limitation, the RAM is available in a variety of forms, such as a static RAM (SRAM), a dynamic RAM (DRAM), a synchronous DRAM (SDRAM), a dual data rate SDRAM (DDRSDRAM), an enhanced SDRAM (ESDRAM), a Synchlink DRAM (SLDRAM), a Rambus direct RDRAM (RDRAM), a direct memory bus dynamic RAM (DRDRAM), and a Rambus dynamic RAM (RDRAM).

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the disclosure as come within known or customary practice in the art. It is intended that the specification and examples be considered as exemplary only, with a true scope and spirit of the disclosure being indicated by the following claims.

It will be appreciated that the disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for processing data, comprising:
obtaining respective current interaction data of each interactive party within a target virtual interaction space in a competition state, the current interaction data comprising a current number of times that a specified interactive action has been performed:
obtaining interaction quota data, a specified competition time length, and a current competition time length of the target virtual interaction space, the interaction quota data comprising a target number of times of performing the specified interactive action; and
sending competition end information to each interactive party, based on the current competition time length not reaching the specified competition time length and the current interaction data of one of interactive parties within the target virtual interaction space satisfying the interaction quota data.

2. The method of claim 1, further comprising:
receiving a competition instruction triggered by a target interactive party within the target virtual interaction space, the competition instruction comprising an identifier of the target virtual interaction space, the specified interactive action, and the interaction quota data:
performing a competition condition-based verification on the target virtual interaction space in response to the competition instruction, and changing a state of the target virtual interaction space into the competition state after passing the competition condition-based verification:
storing a first correspondence between the identifier of the target virtual interaction space and a respective identifier of each interactive party; and
storing a second correspondence between the identifier of the target virtual interaction space, the specified interactive action and the interaction quota data.

3. The method of claim 2, further comprising:
obtaining a target interaction message in response to the competition instruction, the target interaction message indicating that the specified interactive action is performed towards a specified interactive party within the target virtual interaction space, the specified interactive party is any one of the interaction parties within the target virtual interaction space, and the target interaction message comprising a number of times that the specified interactive action is to be performed;
obtaining updated interaction data by updating the current interaction data of the specified interactive party using the number of times that the specified interactive action is to be performed; and
determining the updated interaction data as new current interaction data of the specified interactive party.

4. The method of claim 3, wherein obtaining the target interaction message comprises:
obtaining an interaction message within the target virtual interaction space from a message middleware based on the identifier of the target virtual interaction space, the interaction message indicating that a preset interactive action is performed towards the specified interactive party within the target virtual interaction space:
storing the interaction message in a queue of messages to be combined corresponding to the specified interactive party, based on determining that the preset interactive action is the specified interactive action; and
obtaining the target interaction message by combining, at a preset time interval, interaction messages in the queue of messages to be combined corresponding to the specified interactive party.

5. The method of claim 4, further comprising:
determining the identifier of the target virtual interaction space corresponding to an identifier of the specified interactive party based on the first correspondence; and
determining the specified interactive action corresponding to the identifier of the target virtual interaction space based on the second correspondence.

6. The method of claim 2, further comprising:
obtaining respective historical interaction data of each interactive party in response to an instruction for selecting the specified interactive action triggered by the target interactive party, the historical interaction data comprising a plurality of historical interaction resource identifiers and respective numbers of historical interactions corresponding to the plurality of historical interaction resource identifiers:
determining a recommended interaction resource identifier based on the plurality of historical interaction resource identifiers of each interactive party, one of the plurality of historical interaction resource identifiers of each interactive party matching the recommended interaction resource identifier:
determining recommended quota data based on the number of historical interactions of each interactive party with respect to the recommended interaction resource identifier; and
sending a recommended competition quota to the target interactive party, the recommended competition quota comprising the recommended interaction resource identifier and the recommended quota data.

7. The method of claim 2, further comprising:
updating the state of the target virtual interaction space from the competition state to an interaction state, and starting timing upon the updating:
sending respective current interaction data of each interactive party at a moment when the competition is ended to each interactive party; and
updating the state of the target virtual interaction space from the interaction state to a competition end state based on the timing reaching a specified interaction time length, deleting the first correspondence between the identifier of the target virtual interaction space and the respective identifier of each interactive party, and deleting the second correspondence between the identifier of the target virtual interaction space, the specified interactive action, and the interaction indicator data.

8. The method of claim 1, further comprising:
determining an identifier of the target interactive party who sends the competition instruction as an identifier of an initiating party of the specified interactive action; or
storing color information of an element to be displayed in the target virtual interaction space, the element to be displayed comprising at least one of a name of a winner interactive party among interactive parties, competition result data or a competition special effect to be displayed when the competition is finished in a respective display page of each interactive party.

9. An electronic device, comprising:
a processor; and
a memory for storing instructions executable by the processor: wherein
the processor is configured to:
obtain respective current interaction data of each interactive party within a target virtual interaction space in a competition state, the current interaction data comprising a current number of times that a specified interactive action has been performed:
obtain interaction quota data, a specified competition time length, and a current competition time length of the target virtual interaction space, the interaction quota data comprising a target number of times of performing the specified interactive action; and
send competition end information to each interactive party, based on the current competition time length not reaching the specified competition time length and the current interaction data of one of interactive parties within the target virtual interaction space satisfying the interaction quota data.

10. The electronic device of claim 9, wherein the processor is further configured to:
receive a competition instruction triggered by a target interactive party within the target virtual interaction space, the competition instruction comprising an identifier of the target virtual interaction space, the specified interactive action, and the interaction quota data:
perform a competition condition-based verification on the target virtual interaction space in response to the competition instruction, and change a state of the target virtual interaction space into the competition state after passing the competition condition-based verification:
store a first correspondence between the identifier of the target virtual interaction space and a respective identifier of each interactive party; and
store a second correspondence between the identifier of the target virtual interaction space, the specified interactive action and the interaction quota data.

11. The electronic device of claim 10, wherein the processor is further configured to:
obtain a target interaction message in response to the competition instruction, the target interaction message indicating that the specified interactive action is performed towards a specified interactive party within the target virtual interaction space, the specified interactive party is any one of the interaction parties within the target virtual interaction space, and the target interaction message comprising a number of times that the specified interactive action is to be performed;
obtain updated interaction data by updating the current interaction data of the specified interactive party using the number of times that the specified interactive action is to be performed; and
determine the updated interaction data as new current interaction data of the specified interactive party.

12. The electronic device of claim 11, wherein the processor is configured to:
obtain an interaction message within the target virtual interaction space from a message middleware based on the identifier of the target virtual interaction space, the interaction message indicating that a preset interactive action is performed towards the specified interactive party within the target virtual interaction space;
store the interaction message in a queue of messages to be combined corresponding to the specified interactive party, based on determining that the preset interactive action is the specified interactive action; and
obtain the target interaction message by combining, at a preset time interval, interaction messages in the queue of messages to be combined corresponding to the specified interactive party.

13. The electronic device of claim 12, wherein the processor is further configured to:
determine the identifier of the target virtual interaction space corresponding to an identifier of the specified interactive party based on the first correspondence; and
determine the specified interactive action corresponding to the identifier of the target virtual interaction space based on the second correspondence.

14. The electronic device of claim 10, wherein the processor is further configured to:
obtain respective historical interaction data of each interactive party in response to an instruction for selecting the specified interactive action triggered by the target interactive party, the historical interaction data comprising a plurality of historical interaction resource identifiers and respective numbers of historical interactions corresponding to the plurality of historical interaction resource identifiers;
determine a recommended interaction resource identifier based on the plurality of historical interaction resource identifiers of each interactive party, one of the plurality of historical interaction resource identifiers of each interactive party matching the recommended interaction resource identifier;
determine recommended quota data based on the number of historical interactions of each interactive party with respect to the recommended interaction resource identifier; and
send a recommended competition quota to the target interactive party, the recommended competition quota comprising the recommended interaction resource identifier and the recommended quota data.

15. The electronic device of claim 10, wherein the processor is further configured to:
update the state of the target virtual interaction space from the competition state to an interaction state, and start timing upon the updating;
send respective current interaction data of each interactive party at a moment when the competition is ended to each interactive party; and
update the state of the target virtual interaction space from the interaction state to a competition end state based on the timing reaching a specified interaction time length, delete the first correspondence between the identifier of the target virtual interaction space and the respective identifier of each interactive party, and delete the second correspondence between the identifier of the target virtual interaction space, the specified interactive action, and the interaction indicator data.

16. The electronic device of claim 9, wherein the processor is further configured to:
determine an identifier of the target interactive party who sends the competition instruction as an identifier of an initiating party of the specified interactive action: or
store color information of an element to be displayed in the target virtual interaction space, the element to be displayed comprising at least one of a name of a winner interactive party among interactive parties, competition result data or a competition special effect to be displayed when the competition is finished in a respective display page of each interactive party.

17. A non-transitory computer-readable storage medium, having instructions stored thereon, wherein when the instructions are executed by a processor of an electronic device, the electronic device is caused to perform a method for processing data, the method comprising:
obtaining respective current interaction data of each interactive party within a target virtual interaction space in a competition state, the current interaction data comprising a current number of times that a specified interactive action has been performed;
obtaining interaction quota data, a specified competition time length, and a current competition time length of the target virtual interaction space, the interaction quota data comprising a target number of times of performing the specified interactive action; and
sending competition end information to each interactive party, based on the current competition time length not reaching the specified competition time length and the current interaction data of one of interactive parties within the target virtual interaction space satisfying the interaction quota data.

18. The non-transitory computer-readable storage medium of claim 17, wherein the method further comprises:
receiving a competition instruction triggered by a target interactive party within the target virtual interaction space, the competition instruction comprising an identifier of the target virtual interaction space, the specified interactive action, and the interaction quota data;
performing a competition condition-based verification on the target virtual interaction space in response to the competition instruction, and changing a state of the target virtual interaction space into the competition state after passing the competition condition-based verification;
storing a first correspondence between the identifier of the target virtual interaction space and a respective identifier of each interactive party; and
storing a second correspondence between the identifier of the target virtual interaction space, the specified interactive action and the interaction quota data.

19. The non-transitory computer-readable storage medium of claim 18, wherein the method further comprises:
obtaining a target interaction message in response to the competition instruction, the target interaction message indicating that the specified interactive action is performed towards a specified interactive party within the target virtual interaction space, the specified interactive party is any one of the interaction parties within the target virtual interaction space, and the target interaction message comprising a number of times that the specified interactive action is to be performed;
obtaining updated interaction data by updating the current interaction data of the specified interactive party using the number of times that the specified interactive action is to be performed; and
determining the updated interaction data as new current interaction data of the specified interactive party.

20. The non-transitory computer-readable storage medium of claim 19, wherein obtaining the target interaction message comprises:
obtaining an interaction message within the target virtual interaction space from a message middleware based on the identifier of the target virtual interaction space, the interaction message indicating that a preset interactive action is performed towards the specified interactive party within the target virtual interaction space;
storing the interaction message in a queue of messages to be combined corresponding to the specified interactive party, based on determining that the preset interactive action is the specified interactive action; and
obtaining the target interaction message by combining, at a preset time interval, interaction messages in the queue of messages to be combined corresponding to the specified interactive party.
